(19) United States
(12) Patent Application Publication
(10) Pub. No.: US 2009/0312944 A1
(43) Pub. Date: Dec. 17, 2009

(54) Method and Device for Supplying Location Information

(76) Inventor: Byron King, Carbondale, CO (US)

Correspondence Address: Leyendecker & Lemire, LLC, C/O PORTFOLIO IP, P.O. BOX 52050, MINNEAPOLIS, MN, 55402, US

(21) Appl. No.: 12/136,906

(22) Filed: Jun. 11, 2008

(51) Int. Cl. G01C 21/00

(52) U.S. Cl. 701/207; 701/201

(57) ABSTRACT

A location information display device comprising, a housing coupled to, a distance measuring mechanism, a visual locator, a tilt angle determination mechanism, a compass, a location determination mechanism, and a display. One device is adapted to display an device location and a user-specified distant location position on an area representation.

### FIELD OF THE INVENTION

This invention generally relates to global positioning system (GPS) devices.

### BACKGROUND

It is oftentimes necessary to determine positional information of a viewable distant location located a relatively significant distance away from a person's present location. Furthermore, it is often desired to know how to travel from the present location to the distant location or at least have the ability to view the distant location on a map. For example, hunters, backpackers, day hikers, and equestrian enthusiasts, among others, often want to know how to travel from their current location to a desired distant location when at least one of the present location and desired location are located in remote areas. These types of people may also wish to have the ability to simply view the current location and the distant location on a map or other type of area representation when in the field. Presently it may be difficult to determine how best to travel from the current location to the distant location. In one instance, it may be difficult to ascertain the best travel route for a person situated on a first mountain who wishes to travel to a distant location situated on a second mountain across a valley.

When a person attempts to travel between two positions and the specific terrain between the two positions is unknown, the person may be required to backtrack or otherwise re-route their attempt to reach the distant location if treacherous or otherwise impassable terrain is encountered. This may cause a delay in reaching the desired location, which may have significant consequences. Therefore, it would be convenient for persons traveling by foot, animal, or vehicle, often in remote locations, to have the ability to view how best to travel between a present and a remote location. Specifically, viewing a position of a distant location on a map or other area representation showing terrain features between the present location and distant location in order to more easily, quickly, and safely travel between the two locations is desired.

### SUMMARY OF THE DRAWINGS

FIG. 1A is a side view of a location information display device according to one embodiment of the invention.

FIG. 1B is a rear view of a location information display device according to one embodiment of the invention.

FIG. 1C is an isometric view of a location information display device according to one embodiment of the invention.

FIG. 2 is an isometric view of a valley showing a device location and a distant location according to one embodiment of the invention.

FIG. 3 is a diagram of a location information display device according to one embodiment of the invention.

### DETAILED DESCRIPTION

In order to overcome the above described problems associated with attempting to travel from a present location to a distant location, a device has been developed. One embodiment enables a person unaware of what terrain lies between the two locations to determine the best, most convenient, shortest, or safest route to travel between the two locations. One device may be comprised of a housing substantially enclosing a distance measuring mechanism, a visual locator, a tilt angle determination mechanism, a compass, a location determination mechanism, a display, and an input device.

Operationally, one device is adapted to establish a device location through the location determination mechanism. For example, one location determination mechanism may be a receiver adapted to receive information from a global navigation satellite system. Calculating a second location may require use of the visual locater, the tilt angle determination mechanism, the compass, and the distance measuring mechanism. In one embodiment, the visual locator may be comprised of a telescope having a lens or a plurality of lenses. The telescope may be used in a line-of-sight manner to view a distant, or remote, location.

Upon focusing on an object at the distant location, a user of the device may use the distance measuring mechanism to calculate a line-of-sight distance between the device and the distant location. In one embodiment, the distance measuring mechanism may comprise a laser. Generally simultaneously, the compass may determine a direction the unit is facing. Furthermore, the tilt angle determination mechanism, which may be comprised of an inclinometer, may determine the slope of the device relative to a horizontal plane.

In one embodiment, a microprocessor may operatively receive an electrical signal from a distance measuring mechanism information output device, a compass information output device, and a tilt angle determination mechanism information output device. Together with electrical signal information received from the location determination mechanism, the input device, and a computer memory, the microprocessor may use the information to output a distant location position which may include textual geographical coordinate and elevation information.

In one embodiment, the position of the distant location and the present device location may be received by the display. The display may be adapted to show the two locations on an area representation. For example, the display may be a screen showing a topographical map and the location of the present location and the distant location. One topographical map or other area representation may show terrain features such as, but not limited to, cliffs, water features, and environmental data such as, but not limited to, forest type. Such data may be satellite-originated.

### Terminology:

The terms and phrases as indicated in quotation marks (“”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple”, “coupled”, “coupling”, or any variation thereof, as used in this specification and the appended claims refers to either an indirect or direct connection between the identified elements, components or objects. Often the manner of the coupling will be related specifically to the manner in which the two coupled elements interact. Specifically, this term may be used to define tow elements joined by a bolted fastener, a latch, a hook, or any other reasonably readily removable fastening device.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “operatively” is used herein in a manner similar to “indirectly” in some instances and “sequentially” in others. However, these are not the only definitions for the term operatively, but are relevant in describing how the term modifies the word following the term.

### One Embodiment of a Device for Supplying Location Information:

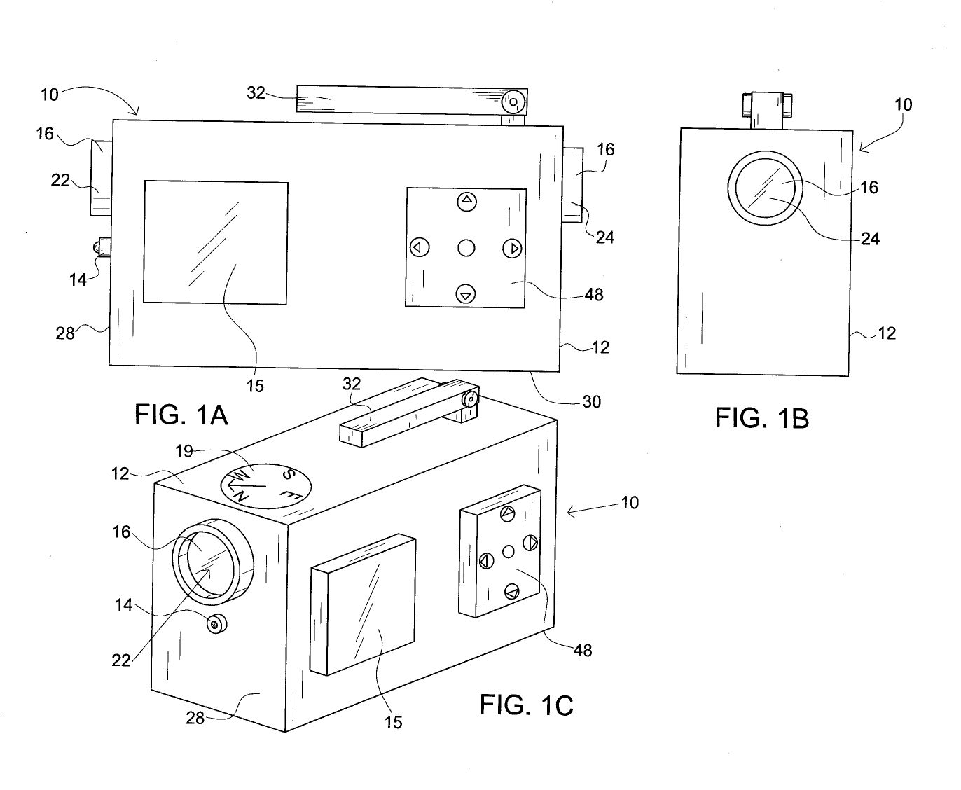

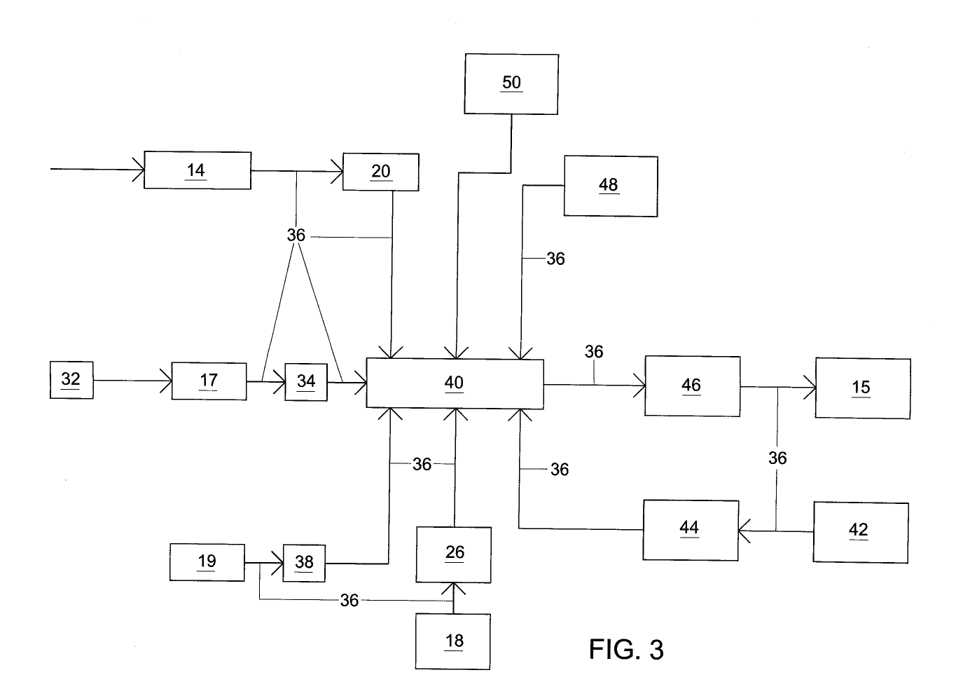

As shown in FIGS. 1A through 1C and FIG. 3, one embodiment of a location information display device 10 may be comprised of a housing 12. The housing may substantially encase portions of various mechanisms, the mechanisms being adapted to work together in determining a device location and a user-specified distant location and then display those locations on an area representation. For example, a display screen may show two locations on a map or a satellite-derived image. Mechanisms substantially enclosed by a housing in one device may comprise a distance measuring mechanism 14, a visual locator 16, a tilt angle determination mechanism 18, a compass 19, a location determination mechanism 17, and a display 15. Working together, these mechanisms potentially along with other mechanisms may be adapted to identify the distant location and show a device location and the distant location on the display.

In one embodiment, the distance measuring mechanism 14 may be comprised of a laser distance measuring mechanism. For example, a laser rangefinder may be used. However, an optical rangefinder may also be used in one embodiment. Furthermore, infrared rangefinders or rangefinders employing radar or sonar may also be used. Combination rangefinders are also contemplated. One rangefinder may be adapted to measure the distance between the device 10 and the distant location. For example, a user may utilize a line-of-sight operation to determine the distance with one of the above distance measuring mechanisms between the device and a user-specified object or location.

The distance measuring mechanism 14 may be further comprised of a distance measuring control circuit 20, as shown in FIG. 3. One distance measuring control circuit may be comprised of electrical components adapted to produce an electrical signal. The electrical signal may vary in strength or other value, depending on the calculated distance of the user-specified object or location.

In one embodiment, the user may first use the magnification lens 16 to locate the distant object or location for which the user wishes to calculate a distance. One magnification lens may be comprised of a monocular telescope adapted to magnify the images of distant objects, the monocular telescope having an objective lens 22 and an eyepiece 24. The eyepiece or the objective may be comprised of a focusing mechanism, which enables the magnification lens to focus on an object or objects at various distances. Once a distant object is located, the distance measuring mechanism may determine the identified object's distance from the device.

In one embodiment, the tilt angle determination mechanism 18 may be a device adapted to determine an angle between a horizontal plane 187 and straight line distance 150 between the device and a user-specified distant location, also known as the tilt angle or slope 175. One tilt angle determination mechanism may be internal to the housing 12. However, a portion of the tilt angle determination mechanism may be viewable by a user (i.e., a bubble leveler). One tilt angle determination mechanism may be comprised of an inclinometer. The inclinometer may be adapted to determine both an inclining angle and a declining angle. One inclinometer may be substantially comprised of mechanical components which may include a generally free-moving ball in a liquid filled tube. Another inclinometer may be comprised of an electrical inclinometer having a capacitor mechanism operatively adapted to determine the device tilt. Further other inclinometers may be comprised of a magnetic mechanism operatively adapted to determine the device tilt. Inclinometers may also be comprised of one or more of these mechanical, electrical, magnetic mechanisms.

One tilt angle determination mechanism 18 may also be comprised of tilt angle control circuit 26, as best shown in FIG. 3. The control circuit may be adapted to produce an electrical signal comprising the tilt angle. The electrical signal may vary in strength or any other value, depending on the slope of the device.

In one embodiment, the compass 19 may be comprised of viewable magnetic compass adapted to determine the direction of a first axis 30 of the device. Furthermore, in one embodiment, the compass may determine which direction a front surface 28 of the device is facing. The front surface and first axis are shown in FIG. 1C. The direction may be given relative to a magnetic north direction. However, the compass may also be comprised of an electronic compass or may be further comprised of both electronic and magnetic features. One compass may also be comprised of a compass control circuit 38 as shown in FIG. 3. The control circuit in one embodiment may convert the directional output to an electrical signal. The electrical signal output from the compass may vary in strength or another value, depending on the direction the unit is facing.

In one embodiment, the location determination mechanism 17 may be adapted to receive satellite-derived positional information. For example, the location determination mechanism may be comprised of an antenna 32 and a global-positioning-system, or GPS, receiver. Whatever the location determination mechanism comprises, the mechanism may produce one or both of elevation information and geographic coordinate system location information. Elevation information may also be given through an altimeter (not shown). Furthermore, the location determination mechanism may also be comprised of a location determination mechanism control circuit 34 adapted to output an electrical signal, as shown in FIG. 3, the strength and other values of which may vary depending on the position and altitude of the unit. One embodiment may receive location information through an operatively coupled antenna 32. The antenna may be operatively coupled to the location determination control circuit.

An embodiment may also be comprised of a plurality of electrical connectors 36, as shown in FIG. 3. Electrical connectors may be coupled to the distance measuring mechanism 14, distance measuring control circuit 20, tilt angle determination mechanism 18, tilt angle control circuit 26, compass 19, compass control circuit 38, location determination mechanism 17, and location determination mechanism control circuit 34. The electrical connectors may operatively transfer or transmit an electrical signal to and from the above listed device features. Furthermore, the electrical connectors may also operatively couple to a microprocessor 40 and may transfer or transmit the various electrical signals to and from the microprocessor. Embodiments are contemplated that have a plurality of microprocessors adapted to send and receive electronic signals.

In one embodiment, at least one microprocessor 40 may be adapted to receive the electrical signal(s) from the above listed devices and convert that signal into output information. For example, the microprocessor may be adapted to output information comprising at least one of the remote location distance and elevation, the device slope, the device direction, and the device location and elevation. To output this information, the microprocessor may employ one or more algorithms.

In one embodiment, at least one microprocessor 40 may operatively access a computer memory 42. One computer memory may be comprised of at least one memory chips which may be accessed through an interface circuit 44. However, other types of computer memory may be used as well. For example, another computer memory may be comprised of a removable computer memory device. Furthermore, the computer memory may comprise one or more algorithms, maps, tables, and other methods, devices, and information adapted to help the microprocessor output the desired information.

Upon operatively receiving information from the distance measuring mechanism 14, the compass 19, the tilt angle determination mechanism 18, the location determination mechanism 17, and the computer memory 42, the microprocessor may be operatively adapted to provide the output to the display 15. In one embodiment, an electronic signal or signals may be sent from the microprocessor or a plurality of microprocessors to an imaging controller 46 as shown in FIG. 3. The imaging controller may be adapted to receive the electronic processor signal and convert the signal to an electronic display signal. The display signal may be adapted to be received by the display and converted to images shown on a screen. In one embodiment, the processor and display signals are adapted to show at least one of a device location on a map, a distant location on a map, and a travel route between the device and the distant location.

One device may be further comprised of software, firmware, or hardware that may be adapted to help the device to display a single device location and at least one remote location on a map, a satellite-derived image, or a combination of the two. In such a device, a user may locate a distant location with a visual locator 18, also known as the magnification lens or viewfinder, and depress at least one button or activate another type of switch. The button may be located on an input device 48. The input device may also be comprised of a touch screen or a keypad. As seen in FIG. 3, in one embodiment, at least one microprocessor 40 may operatively receive information from the keypad 48.

Upon depressing the at least one button, the unit may calculate the output information and display the locations and other data on the screen. With a continuous or semi-continuous device, an updated location and at least one updated remote location may also be displayed. In such a continuous or semi-continuous display, a remote device and at least one new remote location may be preferably displayed on a map preferably at least every 5 minutes, more preferably at least every 1 minute, and most preferably at least every 5 seconds. Therefore, the microprocessor may be adapted to send out at least one generally pulsating signal, with the signal pulse frequency generally equal to the frequency of the updated display. It should be noted that in one embodiment the microprocessor may operatively receive additional electrical signal information beyond the distance button depression. For example, a user may enter location information into the keypad or touch screen, the information adapted to be received by the microprocessor 40. The processor may then use the respective location and other input information, as well as access data from the computer memory to show an output on the display.

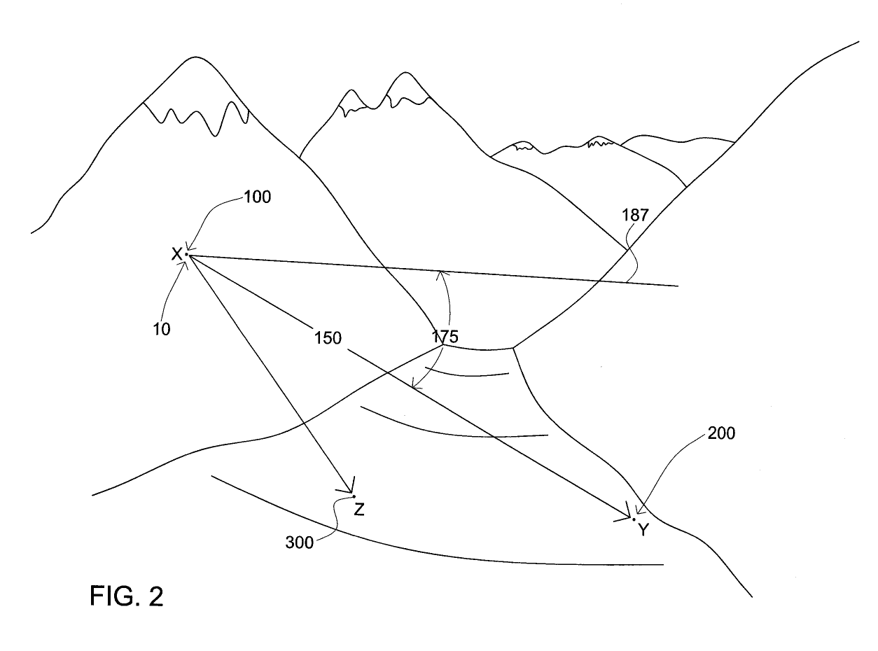

One embodiment may also be comprised of a communication mechanism 50. One communication mechanism may be adapted to at least one of operatively send and receive information between a first unit 100 and a second unit 200, as shown in FIG. 2. One communication mechanism may be comprised of the antenna 32 and may be a portion of the location determination mechanism. The antenna may be adapted to wirelessly send and receive information between the first and second unit. An embodiment is further contemplated that may exchange information between more than two units.

### A Method of Displaying Information on an Area Representation:

As shown in FIG. 3, one method of displaying location information on an area representation may be comprised of a location determination mechanism 17 receiving data from a satellite through an antenna 32. The antenna is also shown in FIG. 1A. The data may be operatively sent to a microprocessor for processing and to obtain at least one of a device 10 location and a device altitude. In displaying a device location and a distant location on an area representation, one method may further comprise determining a straight line distance 150 between the device and a first location. Located at one first location may be a second unit 200, as shown in FIG. 2.

The first location may also be referred to as the distant location in one method. A method may also include determining the slope 175 between the device and the second unit. Furthermore, the direction of where the second unit is located relative to the device and magnetic north may be included. In one method, the slope may be determined as the angle between a horizontal plane 187 and a straight line between the two devices, as shown in FIG. 2. Finally, the method may include displaying at least one of the device location, a device altitude, the first location position, and an altitude of the first location. Furthermore, the method may be comprised of displaying this information, along with an area representation, on a display 15. One such display may be a device screen such as an LCD.

A method may utilize a microprocessor 40. The microprocessor may be adapted to output an electrical signal adapted to be operatively received by the display 15. The signal may be output by a microprocessor comprising an electrical signal generator. The microprocessor may comprise software or firmware applying an algorithm to determine at least one of the location and/or altitude of the device and/or the first location. The display may operatively receive the electrical signal having this information and convert the signal into a visual display of at least one of the location and/or altitude of the device and/or the first location on an area representation. For example, an imaging controller 46 may be used to convert the signal to a signal adapted to be shown by the display.

In one method, a microprocessor 40 outputting an electrical signal may be adapted to apply an algorithm to further calculate the distance 150 and slope 175 between the device 10 and a first location, as shown in FIG. 2. The direction of the first location relative to the device may also be output by the microprocessor. Other devices adapted to output a signal are also contemplated. For example, each device may send a separate signal to the display 15. This distance, slope and direction information may also be operatively received and shown by the display 15.

Further methods may include calculating a distance 150 between the device 10 and at least one additional specified location. For example, as best shown in FIG. 2, a third unit 300 may be located at a second location. Additional units may be located at additional locations. Some locations may not have units. The slope, direction, distance, altitude, and location of these additional units may be calculated by the microprocessor in a similar manner as the second unit. This additional information may also be shown on the display 15.

In order to correctly display the location and other calculated information of the various devices and locations, in one method, data may be entered into the device via an input device 48. For example, in one method, a button may be depressed when a location or an additional device is identified. In one method, an additional location may be selected as a primary location via the input device. One input device may be a touch screen or a keypad operatively adapted to send an electrical signal to the microprocessor 40.

In one method, upon identifying and displaying the device location and at least one additional unit or distant location position, as the additional units or the device move, the position of the additional units, locations, and the device may be updated on the screen. One unit may receive this updated additional unit information through the antenna 32 or through a wired connection to an additional unit. For example, one device may receive location information from an additional unit through an 802.11 wireless connection. All other possible wireless connections are also contemplated.

In receiving location information from a remote device, one method may comprise the ability to receive updated remote device location information as the remote device moves. For example, after a device location and a remote location are calculated and placed on an area representation shown on the display 15, the device may receive and display new device and remote device location information on the display. The display may be updated automatically at least every 5 seconds, 30 seconds, or 5 minutes. Or, the display may be updated only upon receiving a manual input from a user to show an updated display. One type of manual input may be a new calculated line-of-sight distance to the remote device location. Furthermore, updated information on distant locations not having devices at the distant location may also be received through updated line of sight calculations. Other updated information such as, but not limited to textual altitude, geographical co-ordinate, time, and distance may also be displayed.

It is contemplated that all updated present location and distant location(s) information may be saved in textual form or otherwise to a removable memory device or may be transferred wirelessly to a separate memory device. Such information may allow a future user to insert the route of any device recorded in textual form or otherwise to access the information and take the same route as taken by the previous device.

### Alternative Embodiments:

The embodiments of the location information display device and its method of use as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

It is to be appreciated that the device as described herein may be used as a military application, allowing troops the ability to see the exact location of other units having similar devices. Likewise, using enhanced satellite data may provide the ability to determine environmental data between the two locations. This may allow a user the ability to see where dense forests may be avoided or open spaces may be reached between the two locations, allowing for military persons to more easily and quickly reach their destinations. The devices may also be able to be used by the military or other persons in an urban environment.

Furthermore, one embodiment may be adapted to display textual information and may not display location information on an area representation.

I claim:

1) A location information display device comprising, a housing coupled to,
a distance measuring mechanism;
a visual locator;
a tilt angle determination mechanism;
a compass;
a location determination mechanism; and
a display.

2) The device of claim 1 wherein, the distance measuring mechanism comprises,
one of a laser, an optical, an infrared, and a sonic device adapted to measure a distance between the device and a user-specified distant location, the user-specified distant location identified by the visual locator; and
a control circuit adapted to output an electrical signal, the electrical signal comprising distance information.

3) The device of claim 1 wherein,
the visual locator comprises an adjustable telescope, the adjustable telescope adapted to magnify a distant location area.

4) The device of claim 1 wherein, the tilt angle determination mechanism comprises,
at least one of a mechanical, an electronic, and a magnetic inclinometer adapted to determine an angle between a horizontal plane and a straight line between the device and a user-specified distant location; and
a control circuit adapted to output an electrical signal, the electrical signal comprising tilt angle information.

5) The device of claim 1 wherein, the compass comprises,
at least one of an electronic and a magnetic device adapted to determine the direction of a first axis of the device relative to one or a magnetic north and a true north direction;
a viewable needle; and
a control circuit adapted to output an electrical signal, the electrical signal comprising first axis directional information.

6) The device of claim 1 wherein,
the location determination mechanism is adapted to (i) operationally receive satellite-derived positional information through an antenna, the satellite-derived positional information comprising geographic coordinate system information, and (ii) output an electrical signal, the electrical signal comprising geographic coordinate system information.

7) The device of claim 6 wherein, the geographic coordinate system information comprises (i) the location information display device geographic coordinate system information and (ii) at least one distant location geographic coordinate system information.

8) The device of claim 1 further comprising,
an input device;
a plurality of electrical connectors and components; and
at least one microprocessor, the at least one microprocessor adapted to,
operatively receive an electrical signal from at least one of the input device, the distance measuring mechanism, the tilt angle determination mechanism, the compass, and the location determination mechanism, and
output an electrical signal, the output electrical signal (i) adapted to be operatively received by the display, and (ii) comprising device location information and at least one distant location information.

9) The device of claim 8 further comprising, computer memory, the computer memory (i) comprising an area representation, and (ii) operatively coupled to the display.

10) The device of claim 9 wherein,
the area representation comprises, at least one of a map and a satellite generated image; and
the display comprises a screen adapted to exhibit at least one of (i) the device location on at least one of the map and the satellite generated image, and (ii) a distant location on at least one of the map and the satellite generated image.

11) The device of claim 10 wherein,
the microprocessor electrical output signal comprises a generally pulsating electrical output signal; and
the display is adapted to show at least one of a change in the device location and a change in the distant location.

12) A method of displaying information on an area representation comprising,
transmitting data from a satellite to a device;
determining a device location;
determining a distance between the device and a distant location;
determining a slope angle between the device and the distant location;
determining a direction of the distant location relative to the device; and
showing (i) at least one of the device location and the distant location position, and (ii) an area representation on a display.

13) The method of claim 12 wherein,
said determining a distance includes (i) viewing the distant location with a visual locator, and (ii) initiating one of a laser, a sonic, an optical, and an infrared rangefinder by activating an input device to obtain distance information.

14) The method of claim 13 wherein, the input device is at least one of a button, a keypad, and a touch screen.

15) The method of claim 12 further including,
utilizing a microprocessor, the microprocessor (i) receiving one or more electrical signals comprising device location information, distance information, slope angle information, and directional information, (ii) applying an algorithm using at least one of the device location information, the distance information, the slope angle information, and the directional information, and (iii) operatively transmitting output electrical signal information comprising the device location and the distant location position to the display.

16) The method of claim 12 wherein, said showing (i) at least one of the device location and the distant location position and (ii) an area representation on a display comprises,
operatively sending electrical signal output information to a display from a microprocessor;
operatively sending electrical signal area representation information to a display from a computer memory; and
converting the electrical signal output information and the area representation information to a viewable display.

17) A location information display system comprising,
a first portable location information display device comprising,
a distance measuring mechanism,
a visual locator,
a tilt angle determination mechanism,
a compass,
a location determination mechanism comprising a communication mechanism adapted to at least one of send and receive location information between the first portable location information display device and at least one additional portable location information display device,
electrical components, and
a display; and
the at least one additional portable location information display device comprising,
a distance measuring mechanism,
a visual locator,
a tilt angle determination mechanism,
a compass,
a location determination mechanism comprising a communication mechanism adapted to at least one of send and receive location information between the at least one additional portable information location display device and the first portable location information display device,
electrical components, and
a display.

18) The system of claim 17 wherein, the first portable location information display device is adapted to,
determine a distance between the first portable location information display device and the at least one additional portable location information display device;
determine a slope angle between the first portable location information display device and the at least one additional portable location information display device;
determine a direction of the at least one additional portable location information display device relative to the first portable location information device; and
display (i) the location of the first portable location information display device, (ii) the location of the at least one additional portable location information display device, and (iii) an area representation.

19) The system of claim 18 wherein, the first location information display device is further adapted to display changes in at least one of (i) the position of the first portable location information display device on an area representation, and (ii) the position of the at least one additional portable location information display device on an area representation.

20) The system of claim 18 wherein, at least one of the first portable location information display device and the one additional portable location information device is further adapted to
display, at least one of a first device altitude and an at least one additional device altitude; and
select one of the at least one additional specified location as a primary location.
